(19) United States
(12) Patent Application Publication
(10) Pub. No.: US 2026/0010051 A1
(43) Pub. Date: Jan. 8, 2026

(54) SYSTEMS AND METHODS FOR ELECTRO-OPTICAL OPTICALLY ADDRESSABLE LIGHT VALVE (EO-OALV)

(71) Applicants: Lawrence Livermore National Security, LLC, Livermore, CA (US); The Government of the United States as represented by the Secretary of the Navy, Newport, RI (US)

(72) Inventors: Lars F. Voss, Fremont, CA (US); Chatterjee Bikramjit, Kolkata (IN); Qinghui Shao, Fremont, CA (US); Brian Donovan, Annapolis, MD (US)

(21) Appl. No.: 18/763,743

(22) Filed: Jul. 3, 2024

(51) Int. Cl. G02F 1/35; G02F 1/355

(52) U.S. Cl. CPC G02F 1/3503; G02F 1/3551; G02F 2202/20

(57) ABSTRACT

The present disclosure relates to an optically addressable light valve (OALV) which makes use of a non-linear electro-optic crystal. The OALV also has a photoconductor disposed downstream of the non-linear electro-optic crystal, relative to a direction of travel of an optical input beam directed into a first side of the OALV. The OALV is responsive to a DC bias signal to control a magnitude of the input beam passing through the OALV, and responsive to an address beam directed into a second side of the OALV opposite the first side, to produce an output beam using the input beam and the address beam.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to optically addressable light valves, and more particularly to an optically addressable light valve which incorporates an electro-optic crystal to provide beam modulation on a scale of orders of magnitude higher than possible with conventional OALVs incorporating a Twisted Nematic Liquid Crystal (TNLC).

### BACKGROUND

The statements in this section merely provide background information related to the present disclosure and may not constitute prior art.

Optically Addressable Light Valves (“OALVs”) are used for spatial shaping and intensity modulation of laser beams in a wide variety of applications, and particularly in Additive Manufacturing systems. FIGS. 1a and 1b illustrate components of a traditional, well known OALV. The polarization of a long-wavelength (infrared) beam is rotated by 90 degrees after passing through a light modulation layer, typically TNLC (Twisted Nematic Liquid Crystal), and the beam is blocked by a rear polarizer positioned behind it. When a short-wavelength optically-addressed beam is projected into the OALV from the opposite direction, it is absorbed by the photoconductor. This causes a drop in the resistance of photoconductor, and the voltage applied across the OALV is transferred to the TNLC layer. The electric field rearranges the alignment of liquid crystal (“LC”) molecules so that the polarization of the long-wavelength (infrared) beam (typically 1007 nm if produced by a CW diode laser, or 1064 if produced by a Q-switched laser) is kept, and transmission through the rear polarizer is allowed.

One limitation of existing OALVs is that the liquid crystal (“LC”) has a slow response time to an electric field (“e-field”), typically in the range of milliseconds. This serves to limit the refresh rate up to only about 1 KHz, which significantly reduces the overall speed of a 3D printing operation.

Accordingly, a need exists for a new OALV which significantly improves on the response time to changes in an e-field being used to control the OALV.

### SUMMARY

This section provides a general summary of the disclosure, and is not a comprehensive disclosure of its full scope or all of its features.

In one aspect the present disclosure relates to an optically addressable light valve (OALV). The OALV may comprise a non-linear electro-optic crystal and a photoconductor disposed downstream of the non-linear electro-optic crystal, relative to a direction of travel of an optical input beam directed into a first side of the OALV. The OALV is responsive to a DC bias signal to control a magnitude of the input beam passing through the OALV, and responsive to an address beam directed into a second side of the OALV opposite the first side, to produce an output beam using the input beam and the address beam.

In another aspect the present disclosure relates to an optically addressable light valve (OALV) system. The OALV system may comprise an OALV including a non-linear electro-optic crystal, and a photoconductor. The photoconductor may be disposed downstream of the non-linear electro-optic crystal, relative to a direction of travel of an optical input beam directed into a first side of the OALV. The non-linear electro-optic crystal may comprise an LiNBO3 crystal, a KDP crystal or a KD*P crystal. A DC bias voltage signal source is used for generating a DC voltage bias signal across the OALV. The OALV is responsive to the DC voltage bias signal to control a magnitude of the input beam passing through the OALV. The OALV is further responsive to an address beam directed into a second side of the OALV opposite the first side, to pattern the optical input beam and create a patterned output beam.

In still another aspect the present disclosure relates to a method of generating a selectively patterned 2D optical image. The method may comprise generating a 2D optical input beam, and receiving the optical input at a first side of an optically addressable light valve (OALV), wherein the OALV has a non-linear electro-optic crystal. The method may further include applying a DC bias voltage signal across the OALV while transmitting an address image having a bitmapped blocker pattern into a second side of the OALV opposite to the first side. The method may further include using the DC bias voltage signal to control a magnitude of different regions of the 2D optical input beam, while simultaneously using the bit mapped blocker pattern to pattern the optical input beam into a 2D patterned optical output beam patterned in accordance with the bitmapped blocker pattern.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1a is a diagram of a side view of the layer of a typical prior art OALV;

FIG. 1b is a high level, perspective illustration of major components of a typical prior art OALV, and also illustrating how the main beam is projected into a first side of the OALV, and how an optically addressed infrared beam is projected into the opposite side of the OALV, and a bit mapped image that is created by interaction of the addressed beam and the liquid crystal;

FIG. 2 is an exploded perspective view of a new OALV in accordance with the present disclosure which incorporates a non-linear electro-optic crystal in place of the TNLC used in a prior art OALV;

FIG. 3 is a graph illustrating the voltage drop across the non-linear electro-optic crystal, where the crystal is a LiNbO₃ non-linear electro-optic crystal, wherein the X axis is voltage drop across the non-linear electro-optic crystal and the Y axis indicates a percentage of magnitude of transmission of the input beam 118 through the OALV 100;

FIG. 4 is a highly enlarged, simplified side view of another embodiment of an OALV in accordance with the present disclosure which incorporates a KDP non-linear electro-optic crystal;

FIG. 4a shows a graph illustrating transmission vs. phase difference for the LiNbO₃ crystal of FIG. 3;

FIG. 4b shows a graph of phase difference vs. e-field (kV/cm) along with points of maximum transmission and extinction, for the LiNbO₃ crystal shown in FIG. 3;

FIG. 4c shows a graph of transmission vs. applied voltage (kV) for the KDP non-linear electro-optic crystal shown in FIG. 4;

FIG. 5 shows a graph of transmission vs. applied electric field (kV/cm) for a KD*P non-linear electro-optic crystal;

FIG. 6 shows a graph of transmission vs. phase difference for a KD*P non-linear electro-optic crystal; and

FIG. 7 shows a graph of the phase difference vs. electric field for a KD*P non-linear electro-optic crystal.

### DETAILED DESCRIPTION

Example embodiments will now be described more fully with reference to the accompanying drawings.

The present disclosure relates to a new OALV which provides orders of magnitude higher modulation frequency than heretofore manufactured OALVs. The new OALV of the present disclosure also provides greater mechanical robustness and higher temperature tolerance than traditional, pre-existing OALVs.

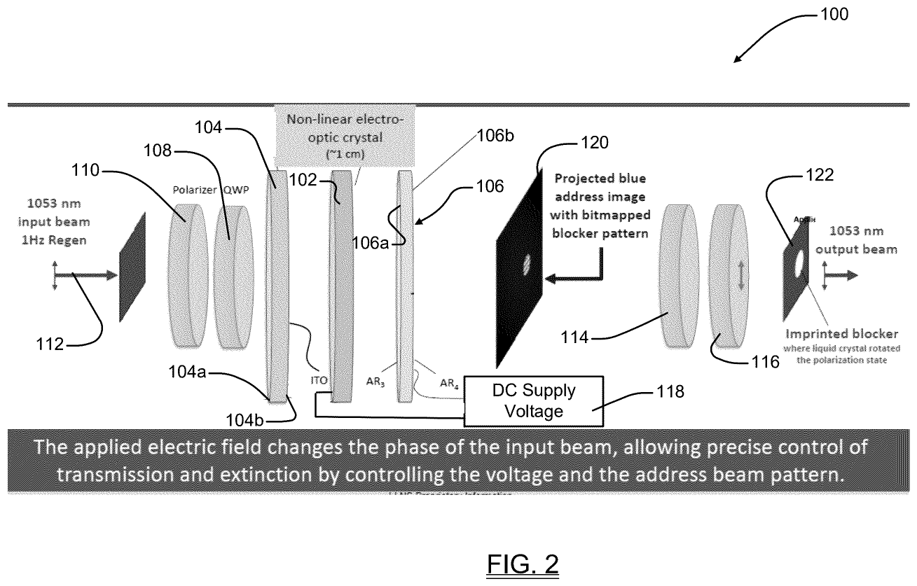

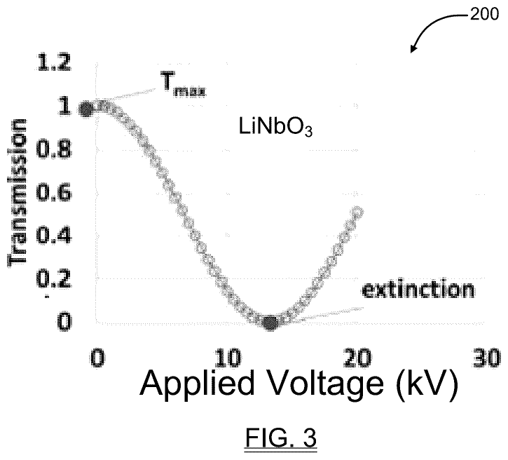

Referring to FIG. 2, an exploded perspective view of one embodiment of a new OALV 100 of the present disclosure is shown. In this example the new OALV 100 includes a non-linear, electro-optic crystal 102, an optional substrate 104, and a photoconductor 106. The non-linear electro-optic crystal 102 replaces the TNLC in a conventional OALV system. The non-linear electro-optic crystal 102 may vary in thickness, typically from about 0.5 mm to about 2 cm, but in one example and without limitation, the thickness may be about 1 cm. In one implementation the substrate 104, if incorporated, is formed from BK-7 (Borosilicate crown glass) and is disposed adjacent a first surface of the non-linear electro-optic crystal 102. Other possible materials for the substrate 104 may include, without limitation, fused silica and sapphire. The substrate 104 may vary in thickness, but in one example has a thickness of about, without limitation, 2 mm-4 mm, and in some embodiments about 3 mm. The substrate 104 also may have anti-reflective surfaces 104a and 104b on opposing surfaces thereof. As noted earlier, the substrate is optional because, in most applications, the electro-optic crystal 102 is thick enough that the device does not need a substrate. However, for some applications the substrate, when made of high thermal conductivity material such as sapphire, can enhance heat extraction from the device. For the LC-based OALV (prior art), the substrate is used to hold the liquid crystal within the gap between itself and the photoconductor.

The OALV 100 may be used with a quarter wave polarizer plate 108 and a half wave polarizer plate 110 arranged upstream of the OALV 100, relative to a direction of travel of an input beam 112 directed into the OALV. The photoconductor 106 may be disposed adjacent a second, opposite surface of the non-linear electro-optic crystal 102. The photoconductor 106 may be formed from suitable materials, for example and without limitation, from the Wide Band Gap/Ultra Wide Band Gap (WBG/UWBG) family (i.e., 4H/6H—SiC, Mn—GaN, AlN), and may have a thickness of, without limitation, about 0.25 mm-1 cm. The photoconductor 106 may have antireflective coatings 106a and 106b on opposing surfaces thereof. A quarter waveplate 114 and a polarizer 116 may be disposed adjacent the photoconductor 106. The quarter wave plate 114 and polarizer 116 do not form a portion of the OALV 100, however, they are integral part of the OALV system.

Referring further to FIG. 2, a DC voltage supply source 118 applies a DC bias signal (e.g., in the kV range) across the non-linear electro-optic crystal 102 and the photoconductor 106. The DC bias signal controls the magnitude of the optical input beam 112 transmitted through the OALV 100. The DC bias signal in most cases will be a constant DC bias signal, but in some implementations a variable DC bias signal could be used as well. For an application where the half wave voltage is small enough that an AC supply can be applied, the AC supply has to be faster than the OALV switching speed so as to not be the factor limiting the time response. In the present case, the half wave voltage is ˜kV level, so a DC supply is suitable.

As with previously existing OALVs, the new OALV 100 receives the input beam into beam 112 as well as the address image 120 from opposite sides of the OALV. The address image 120 forms a bitmapped blocker pattern. An output beam 122 is thus produced by the OALV 100 which modifies the input beam 112 such that the output beam is imprinted with the blocker pattern. The output beam 122 thus forms a 2D image (e.g., in some instances a patterned 2D image for AM manufacturing applications) which may be used in a subsequently additive manufacturing process to form a layer of a 3D part.

In some embodiments, without limitation, the electro-optic crystal 102 may be a LiNbO₃ crystal, and in some embodiments the electro-optical crystal may be a KDP crystal. Possibly other crystals such as KD*P/DKDP or BTO. The LiNbO₃ electro-optic crystal has been used for optical sensors of an electric field, and the KDP crystal is also widely used in National Ignition Facility laser systems operated by Lawrence Livermore National Laboratory. The LiNbO₃ crystal, as well as a KDP crystal, both have an especially high laser damage threshold (>10 J/cm2 at 1064 nm, 10 ns). The optical response of the non-linear electro-optic crystal 102 to the electric field is very high at >1 GHz, compared to only about 1 kHz for a liquid crystal. This dramatically increased damage tolerance enables ultrahigh speed laser modulation during the 3D printing process.

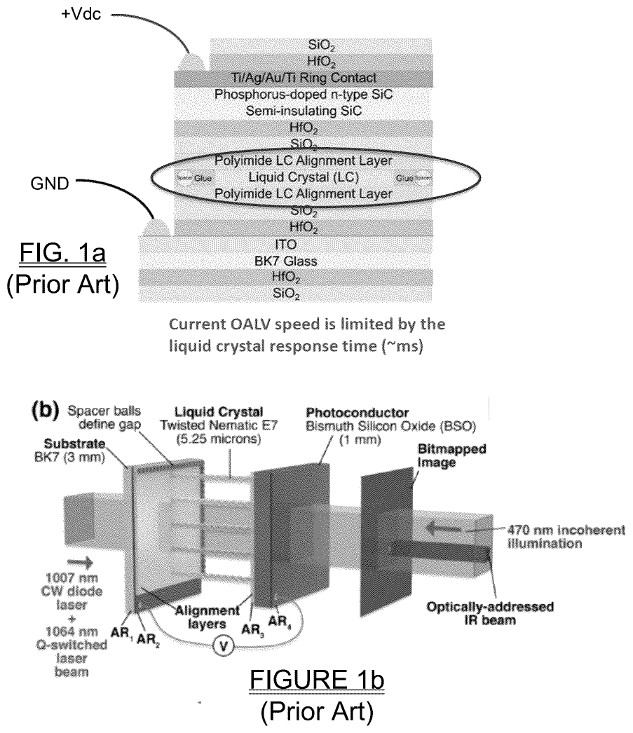

Unlike a traditional TNLC based OALV (FIG. 1b), in which the device is driven by AC power source, the OALV 100 forms a solid-state OALV which is driven by a DC bias signal with high voltage. The crystal robustness has been demonstrated in DC e-field sensing.

In the example embodiment shown in FIG. 2, the OALV 100 makes use of the linear polarizer 110 and the quarter-wave-plate 108 in front of the substrate 104, and the additional linear polarizer 116 is disposed behind (i.e., downstream, relative to the direction of travel of the input beam 112) the photoconductor 106. With brief reference to FIG. 2a, an embodiment of the OALV 100′ is shown without the substrate. In this configuration, a KDP electro-optic crystal 102′ is used and disposed upstream, relative to a direction of travel a primary beam 112′, of a photoconductor 106′. A dichroic mirror 101′ is used to steer an address beam 120′ into a path of travel of the primary beam 112′. A first polarizer 110′ and first quarter wave plate 108′ are disposed upstream of the photoconductor 106′, while a second quarter wave plate 114′ and a second polarizer 116′ are disposed downstream of the KDP electro-optic crystal 102′. Transparent conductive oxide coatings (TCOs) 103′ are disposed on a surface of the photoconductor 106′ and the KDP electro-optic crystal 102′, and are coupled to the DC voltage supply 118.

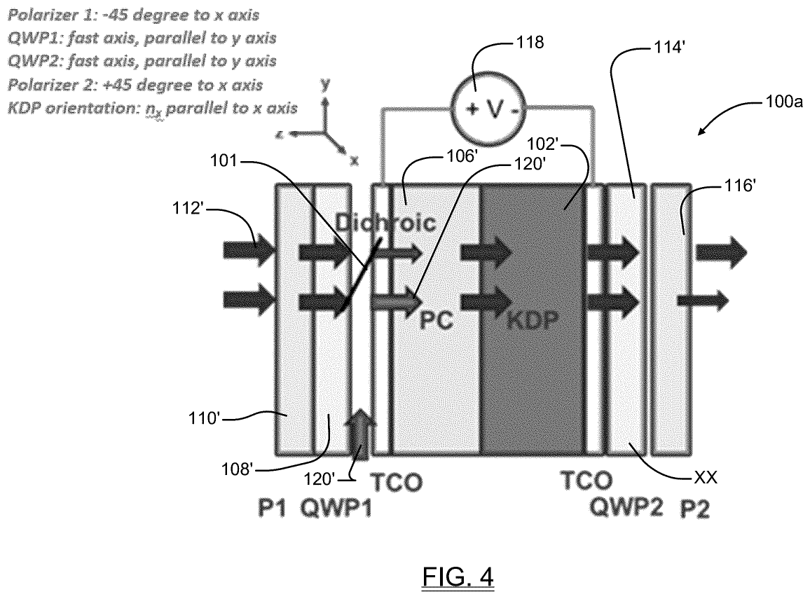

The relative angles between these three optical components (components 110, 108 and 116) and the optical axis of the electro-optic crystal 102 have an impact on the polarization and intensity of the input beam 112 passing through the OALV 100. The refractive index of the electro-optic crystal 102 is modified by the e-field which is delivered through the photoconductor 106. An example of one suitable device configuration for the OALV 100 is as follows: polarizer 110 is placed-45 degree off the y axis, the quarter wave plate (QWP) 108 is placed with its fast axis along the y axis, and polarizer 116 is placed +45 degree off the y axis. FIG. 3 shows the calculated polarization and intensity of an infrared laser beam (1064 nm) passing through the first polarizer 108, the quarter wave plate 106, the electro-optic crystal 102 with 0.6*pi phase difference (c), and the second polarizer 116. The phase difference is controlled by applying the e-field through address beam absorption in the photoconductor 110.

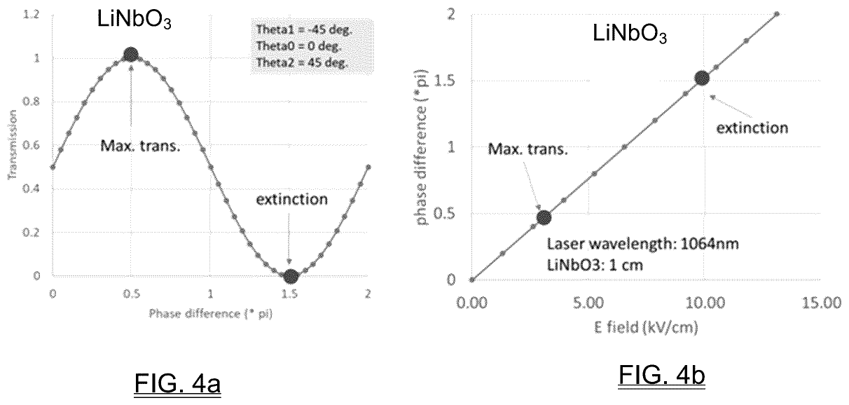

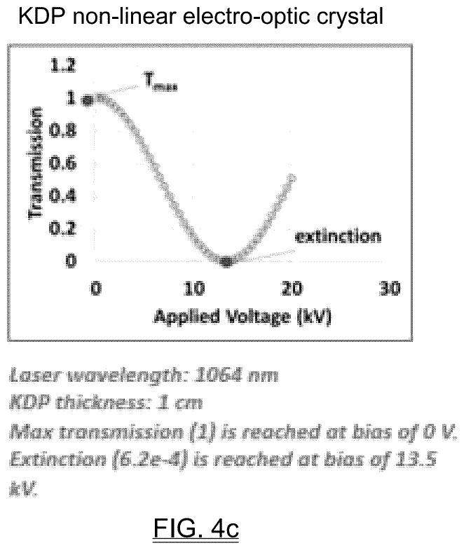

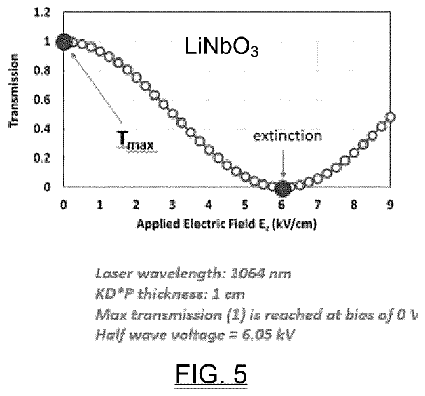

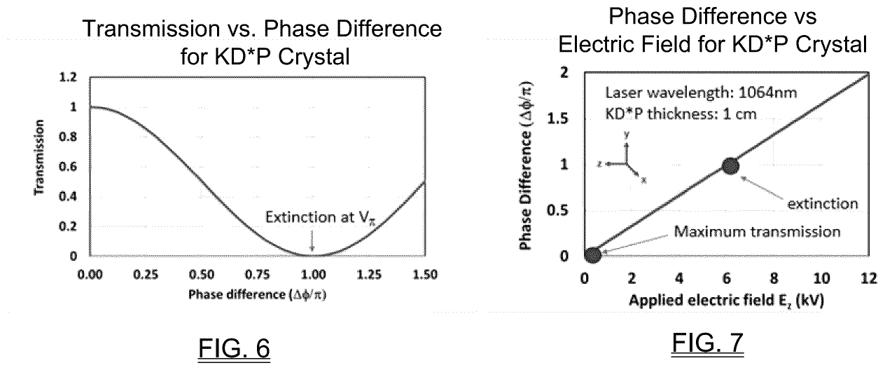

The dependence of transmission on phase difference and the dependence of phase difference on electric field are shown in FIGS. 4a and 4b and 5, respectively. These figures pertain to a LN electro-optic crystal.

The maximum transmission, as shown in FIG. 4b, appears at 0.5*pi and extinction is shown at 1.5*pi, and the corresponding e-field is 3.2 kV/cm and 10 kV/cm. The phase difference can be offset by employing additional quarter wave plate 114′ (refer FIG. 4). The phase difference (FIG. 4a) is linearly proportional to the e-field, so the transmission has a sinusoidal relationship with the e-field. Unlike the traditional liquid crystal based OALV, in which a sharp transmission transition is observed in a small voltage range of 1-2 Vac, the sinusoidal transition produced by the OALV 100 benefits the device operation in gray mode, in which the infrared laser intensity is almost linearly controlled by adjusting the address beam intensity. Adjustment of the address beam intensity may be accomplished by a separate electronic controller or computer. In some embodiments a power supply may be used to control the current into the address beam 112 (or address beam 112′), thus controlling the intensity. FIG. 4c shows a graph of transmission vs. applied voltage for the KDP non-linear electro-optic crystal of FIG. 4.

FIG. 3 shows a graph 200 to illustrate the voltage drop across the non-linear electro-optic crystal, where the crystal is a LiNbO₃ crystal. The X axis is voltage drop across the non-linear electro-optic crystal 102 (in this example a KDP crystal for the case of this specific simulation). The Y axis indicates a percentage of magnitude of transmission of the 1064 nm wavelength input beam 118 through the OALV 100. The magnitude of transmission of the 1064 nm wavelength input beam 118 can be controlled by controlling the voltage drop across the non-linear electro-optic crystal 102. In order to control the voltage drop across the non-linear electro-optic crystal 102, the address beam is used to activate the photoconductor 110 and reduce the resistivity of the photoconductor. This results in a reduction in the voltage drop across the photoconductor 110 and an increase in voltage drop across the non-linear electro-optic crystal 102. By controlling the address beam power, one can thus control voltage drop across the non-linear electro-optic crystal 102. It will also be appreciated that the address beam can be projected using a projector, which can be used to control the address beam power spatially, thus giving one the option to generate a 2D “pixelated” map across the non-linear electro-optic crystal 102.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An optically addressable light valve (OALV) comprising:
a non-linear electro-optic crystal; and
a photoconductor disposed downstream of the non-linear electro-optic crystal, relative to a direction of travel of an optical input beam directed into a first side of the OALV; and
the OALV responsive to a DC bias signal to control a magnitude of the input beam passing through the OALV, and responsive to an address beam directed into a second side of the OALV opposite the first side, to produce an output beam using the input beam and the address beam.

2. The OALV of claim 1, wherein the non-linear electro-optic crystal comprises a LiNbO₃ crystal.

3. The OALV of claim 1, wherein the non-linear electro-optic crystal comprises one of a KDP crystal or KD*P crystal.

4. The OALV of claim 1, further comprising a substrate secured to a first surface of the non-linear electro-optic crystal.

5. The OALV of claim 4, wherein the substrate comprises BK7 optical glass.

6. The OALV of claim 1, wherein the non-linear electro-optic crystal has a thickness between ½ mm-1 cm.

7. The OALV of claim 1, wherein the photoconductor comprises of at least one of Wide Band Gap/Ultra Wide Band Gap (WBG/UWBG) family of materials.

8. The OALV of claim 7, wherein the photoconductor is comprised of at least one of: 4H/6H-SiC, Mn—GaN or AlN.

9. The OALV of claim 1, wherein the photoconductor has a thickness of between 0.25 mm-1 mm.

10. The OALV of claim 1, further comprising a quarter wave plate disposed upstream of the OALV relative to a direction of travel of the optical input beam.

11. The OALV of claim 10, further comprising a polarizer disposed upstream of the quarter wave plate, relative to the direction of travel of the optical input beam.

12. The OALV of claim 1, further comprising a DC bias supply source for applying a DC bias signal across the non-linear electro-optic crystal and the photoconductor.

13. The OALV of claim 1, further comprising an quarter wave plate disposed downstream of the photoconductor, relative to the direction of travel of the optical input beam.

14. The OALV of claim 13, further comprising a polarizer disposed downstream of the quarter wave plate, relative to the direction of travel of the optical input beam.

15. An optically addressable light valve (OALV) system comprising:
an OALV including:
a non-linear electro-optic crystal; and
a photoconductor disposed downstream of the non-linear electro-optic crystal, relative to a direction of travel of an optical input beam directed into a first side of the OALV;
the non-linear electro-optic crystal comprising at least one of LiNbO₃, KDP or KD*P;
a DC bias voltage signal source for generating a DC voltage bias signal across the OALV; and
the OALV being responsive to the DC voltage bias signal to control a magnitude of the input beam passing through the OALV, and the OALV further being responsive to an address beam directed into a second side of the OALV opposite the first side, to pattern the optical input beam and create a patterned output beam.

16. The OALV system of claim 15, further comprising a substrate disposed upstream of the non-linear electro-optic crystal, relative to the direction of travel of the optical input beam.

17. The OALV system of claim 15, further comprising:
a first quarter wave plate disposed upstream of the OALV, relative to the direction of travel of the optical input beam;
a first polarizer disposed upstream of the first quarter wave plate, relative to the direction of travel of the optical input beam;
a second quarter wave plate disposed downstream of the OALV, relative to the direction of travel of the optical input beam; and
a second polarizer disposed downstream of the second quarter wave plate, relative the direction of travel of the optical input beam.

18. The OALV system of claim 15, wherein the non-linear electro-optic crystal has a thickness of about ½ mm to 1 cm.

19. The OALV system of claim 15, wherein the photoconductor comprises at least one of 4H/6H—SiC, Mn—GaN or Ain.

20. A method of generating a selectively patterned 2D optical image, comprising;
generating a 2D optical input beam;
receiving the optical input at a first side of an optically addressable light valve (OALV), wherein the OALV has a non-linear electro-optic crystal;
applying a DC bias voltage signal across the OALV while transmitting an address image having a bitmapped blocker pattern into a second side of the OALV opposite to the first side; and
using the DC bias voltage signal to control a magnitude of different regions of the 2D optical input beam, while simultaneously using the bit mapped blocker pattern to pattern the optical input beam into a 2D patterned optical output beam patterned in accordance with the bitmapped blocker pattern.
